(19) United States
(12) Patent Application Publication
(10) Pub. No.: US 2025/0138040 A1
(43) Pub. Date: May 1, 2025

(54) SYSTEM MODULES FOR USE WITH FLUID SAMPLE PROCESSING SYSTEMS

(71) Applicant: Correlia Biosystems, Inc., Berkeley, CA (US)

(72) Inventors: M. Kursad Araz, El Cerrito, CA (US); Pranav Sundaram, Berkeley, CA (US); Robert Ray, Oakland, CA (US); Akwasi A. Apori, Oakland, CA (US); Samuel Quinn Tia, Berkeley, CA (US)

(21) Appl. No.: 18/835,324

(22) PCT Filed: Feb. 3, 2023
(86) PCT No.: PCT/US2023/012326

§ 371 Date: Aug. 1, 2024

Related U.S. Application Data
(60) Provisional application No. 63/306,467, filed on Feb. 3, 2022.
(60) Provisional application No. 63/306,427, filed on Feb. 3, 2022.

(51) Int. Cl. G01N 35/10

(52) U.S. Cl. CPC G01N 35/1009; G01N 35/1072; G01N 2035/103

(57) ABSTRACT

A system module configured to be installed into and removed from a separate fluid sample processing system can include an aspiration submodule, a pneumatic submodule, and a control submodule. The aspiration submodule can be configured to receive a chip module having assay devices and to provide aspiration for the chip module. The pneumatic submodule can be coupled to the aspiration submodule and can include passages configured to deliver vacuum to and receive fluids from the chip module and valves coupled to the passages. The control submodule can be coupled to the pneumatic submodule and can include a controller configured to operate the valves. The aspiration submodule can include a lid that allows the chip module to be inserted and removed and can be configured to perform operations on the chip module when it is within the aspiration submodule and the lid is closed.

### CROSS-REFERENCE TO RELATED APPLICATIONS

This application claims the benefit of U.S. Provisional Patent Application No. 63/306,427 filed Feb. 3, 2022, entitled “SYSTEM MODULES FOR USE WITH FLUID SAMPLE PROCESSING SYSTEM,” which application is hereby incorporated by reference in its entirety herein. This application also claims the benefit of U.S. Provisional Patent Application No. 63/306,467 filed Feb. 3, 2022, entitled “AUTOMATED ANALYTE MEASUREMENT SYSTEMS AND KITS FOR USE THEREWITH,” which application is hereby incorporated by reference in its entirety herein.

### TECHNICAL FIELD

The present disclosure relates generally to fluid sample processing, and more particularly to components for analyte measurement systems.

### BACKGROUND

Fluid sample processing can involve the detection, identification and quantification of small molecules and macromolecules in fluid samples for purposes of research, clinical applications, diagnosis, treatment, and related endeavors. Such molecules and macromolecules can include, for example, proteins, peptides, antibodies, nucleic acid markers, hormones, metabolites, carbohydrates, lipids, and the like. Commercially available fluid processing systems can include various robotically controlled components for the delivery, analysis, removal, and disposal of fluids of interest. Such fluids are commonly delivered to assay chips using an array of pipets, where the fluids are then analyzed and then removed using the same or a different array of pipets.

Unfortunately, there are several drawbacks to conventional fluid processing systems. In such systems, fluids are commonly delivered to the tops of the assay chips by way of pipets and then aspirated or otherwise removed from the tops of the chips by pipets. This process can be time consuming, involving many steps, and fluid removal can often be inaccurate, resulting in residual fluids left behind. Furthermore, while many such fluid processing systems are robotically controlled to some extent, these systems still inconveniently require a significant amount of manual intervention and steps. For example, some arrays of assay chips require a user to stop an automated process to intervene manually in order to remove or replace parts of the chip array before the processing and analysis of further fluids. This lack of modularity can be disadvantageously time consuming, labor intensive, and prone to operator error.

Although traditional fluid sample processing systems and processing techniques have worked well in the past, improvements are always helpful. In particular, what is desired are improved fluid sample processing systems and components thereof that are more modular in order to facilitate faster, more automated, and more accurate fluid sample processing, with little to no residual fluids left behind.

### SUMMARY

It is an advantage of the present disclosure to provide improved fluid sample processing systems and components thereof that are more modular in order to facilitate faster, more automated, and more accurate fluid sample processing, with little to no residual fluids left behind. The disclosed systems, apparatuses, methods, and features thereof include modular fluid processing components that provide faster, more automated, and more accurate fluid aspiration from assay chips during fluid processing. This can be accomplished at least in part due to readily installable and removable system modules configured to support assay chip modules having innovative aspiration channels and associated components that facilitate improved aspiration through these aspiration channels.

In various embodiments of the present disclosure, a system module configured for use with a separate fluid sample processing system can include an aspiration submodule, a pneumatic submodule, and a control submodule. The aspiration submodule can be configured to receive a separate chip module having one or more assay devices and to provide aspiration for the separate chip module. The pneumatic submodule can be coupled to the aspiration submodule and can include a plurality of passages configured to deliver vacuum to and receive fluids from the separate chip module and one or more valves coupled to the plurality of passages. The control submodule can be coupled to the pneumatic submodule and can include a controller configured to operate the one or more valves.

In various detailed embodiments, the system module can be configured to be installed into and removed from the separate fluid sample processing system. The system module can also include one or more coupling components configured to couple the system module to the separate fluid sample processing system and can also include a communication interface configured to facilitate communication with a separate processor. The aspiration submodule can include a reception configured to receive the separate chip module, a lid configured to allow the separate chip module to be inserted and removed to the reception, one or more electrical connections configured to deliver voltage to the separate chip module, and one or more pneumatic ports configured to deliver vacuum to and receive fluids from the separate chip module. The aspiration submodule can also include one or more sensors configured to detect the presence of the separate chip module within the aspiration submodule. In various arrangements, the system module can be configured to perform operations on the separate chip module when the separate chip module is within the aspiration submodule and the lid is closed. Also, the aspiration submodule and the pneumatic submodule can be contained within a unibody outer housing. In addition, the one or more valves can be arranged into at least one valve manifold within the pneumatic submodule.

In various further embodiments of the present disclosure, a fluid sample processing subsystem configured for use with an overall fluid sample processing system can include a system module and a waste disposal module. The system module can include an aspiration submodule configured to receive a removable chip module having one or more assay devices and to provide aspiration for the separate chip module, a pneumatic submodule coupled to the aspiration submodule, the pneumatic submodule including a plurality of passages configured to deliver vacuum to and receive fluids from the removable chip module and one or more valves coupled to the plurality of passages, and a control submodule coupled to the pneumatic submodule, the control submodule including a controller configured to operate the one or more valves. The waste disposal module can be configured to be coupled to the system module and can include a removable waste disposal unit configured to hold waste materials from the system module, and a vacuum source coupled to the removable waste disposal unit. The vacuum source can be configured to provide a vacuum to the system module to remove the waste materials from the system module and deposit the waste materials into the removable waste disposal unit.

In various detailed embodiments, the fluid sample processing subsystem can also include the removable chip module. The removable chip module can include one or more assay devices arranged into one or more rows. The one or more assay devices can include one or more wells configured to hold fluid therein and one or more aspiration channels connected to the one or more wells. The one or more aspiration channels can be configured to aspirate fluid from the bottoms or the sides of the one or more wells. In various arrangements, the fluid sample processing subsystem can also include a processing component configured to analyze fluid content within the removable chip module, and/or an interface component configured to couple the system module to a separate fluid sample processing system.

In still further embodiments of the present disclosure, various methods of processing fluid samples are provided. Pertinent method steps can include opening a system module, placing a chip module, closing the system module, placing a fluid, analyzing fluid content, actuating one or more valves, delivering a vacuum, and aspirating the fluid. The system module can be opened while it is installed in a separate fluid sample processing system, and the system module can include an aspiration submodule, a pneumatic submodule, and a control submodule. The chip module can be placed within the aspiration submodule, and the chip module can include one or more assay devices arranged into one or more rows, the one or more assay devices including one or more wells configured to hold fluid therein and one or more aspiration channels connected to the one or more wells. Closing the system module can occur with the chip module placed therein. The fluid can be placed into the top of each of the one or more wells while the system module remains closed. Analyzing content in the fluid within the one or more wells can also take place while the system module remains closed. Actuating one or more valves within the pneumatic submodule can also take place while the system module remains closed, and the actuating can be performed by the control submodule. The vacuum can be delivered to a plurality of passages within the pneumatic submodule, and the delivering a vacuum can result from the actuating. Aspirating the fluid can be by way of the vacuum from the bottom or the side of each of the one or more wells while the system module remains closed.

In various detailed embodiments, the placing, the analyzing, the actuating, the delivering, and the aspirating can all be automatically performed by a robotic system. Aspirating of the fluid can occur simultaneously for some or all of the one or more wells. Additional process steps can include removing the chip module from the aspiration submodule, collecting aspirated fluid into a waste disposal unit, and/or installing the system module within the separate fluid sample processing system.

Other apparatuses, methods, features, and advantages of the disclosure will be or will become apparent to one with skill in the art upon examination of the following figures and detailed description. It is intended that all such additional apparatuses, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed systems, apparatuses, features, and methods relating to system modules for use with fluid sample processing systems. These drawings in no way limit any changes in form and detail that may be made to the disclosure by one skilled in the art without departing from the spirit and scope of the disclosure.

FIG. 1 illustrates in schematic view an example fluid sample processing system.

FIG. 2A illustrates in front perspective view an example fluid sample processing system according to one embodiment of the present disclosure.

FIG. 2B illustrates in alternative perspective view the fluid sample processing system of FIG. 2A according to one embodiment of the present disclosure.

FIG. 3 illustrates in top perspective view an example chip module according to one embodiment of the present disclosure.

FIG. 4A illustrates in front perspective view the chip module of FIG. 3 inside an open system module according to one embodiment of the present disclosure.

FIG. 4B illustrates in front perspective view the chip module of FIG. 3 inside a closed system module according to one embodiment of the present disclosure.

FIG. 5A illustrates in front cross-section view an example chip module within a system module according to one embodiment of the present disclosure.

FIG. 5B illustrates in side cross-section view an example chip module within a system module according to one embodiment of the present disclosure.

FIG. 6 illustrates in front perspective view an example system module for a fluid sample processing system according to one embodiment of the present disclosure.

FIG. 7 illustrates in obverse side perspective view an example system module for a fluid sample processing system according to one embodiment of the present disclosure.

FIG. 8A illustrates in obverse side perspective view an example control submodule of a system module according to one embodiment of the present disclosure.

FIG. 8B illustrates in exploded view the control submodule of FIG. 8A according to one embodiment of the present disclosure.

FIG. 9 illustrates in exploded view example aspiration and pneumatic submodules of a system module according to one embodiment of the present disclosure.

FIG. 10 illustrates in top perspective view an example aspiration submodule of a system module according to one embodiment of the present disclosure.

FIG. 11 illustrates in top perspective view an example pogo pin and sensor support bracket for an aspiration submodule according to one embodiment of the present disclosure.

FIG. 12A illustrates in side elevation view an example holding arrangement for a lid of a system module with the lid in a closed position according to one embodiment of the present disclosure.

FIG. 12B illustrates in side elevation view the holding arrangement of FIG. 12A with the lid in an open position according to one embodiment of the present disclosure.

FIG. 13 illustrates in side perspective view an example pneumatic manifold for use within a system module according to one embodiment of the present disclosure.

FIG. 14 illustrates in side perspective and partial cutaway view an example external box according to one embodiment of the present disclosure.

FIG. 15 illustrates a flowchart of an example method of processing fluid samples according to one embodiment of the present disclosure.

### DETAILED DESCRIPTION

Exemplary applications of apparatuses, systems, and methods according to the present disclosure are described in this section. These examples are being provided solely to add context and aid in the understanding of the disclosure. It will thus be apparent to one skilled in the art that the present disclosure may be practiced without some or all of these specific details provided herein. In some instances, well known process steps have not been described in detail in order to avoid unnecessarily obscuring the present disclosure. Other applications are possible, such that the following examples should not be taken as limiting. In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, such that other embodiments may be used, and changes may be made without departing from the spirit and scope of the disclosure.

The present disclosure relates in various embodiments to systems, apparatuses, features, and methods involving system modules for use with fluid sample processing systems. In particular, the disclosed embodiments provide fluid sample processing system modules and components thereof that facilitate faster, more automated, and more accurate fluid sample processing, with little to no residual fluid left behind. Such components can include system modules and associated system components configured for use with assay chip modules having innovative aspiration channels and associated features that facilitate improved aspiration through these aspiration channels. The disclosed system modules can be readily installable and removable, which advantageously facilitates ease of handling and saves time and steps in overall fluid sample processing.

Although the various embodiments disclosed herein focus on fluid sample processing involving the detection, identification and quantification of small molecules and macromolecules for purposes of simplicity in illustration, it will be readily appreciated that the disclosed systems, apparatuses, features, and methods can similarly be used for any other kind of fluid handling system. For example, the disclosed systems, apparatuses, features, and methods can be used for other fluid handling systems that can take advantage of the innovative modular and improved aspiration aspects disclosed herein to realize automated, faster, and more accurate fluid handling.

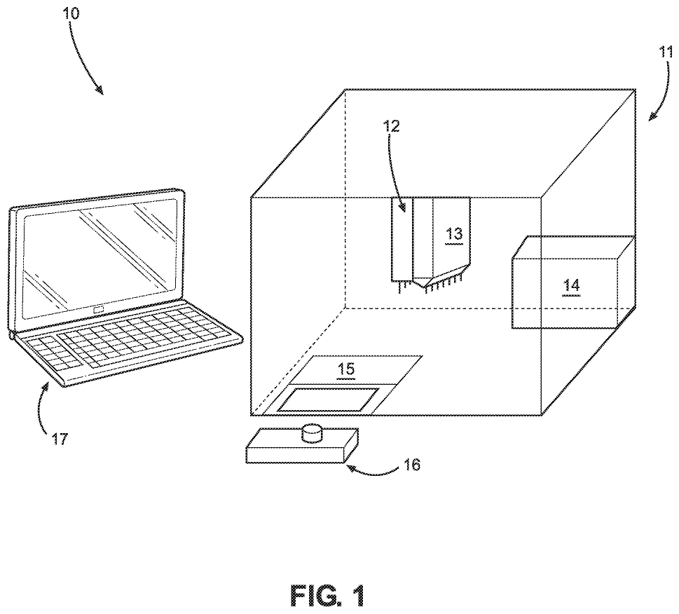

Referring first to FIG. 1, an example fluid sample processing system is shown in schematic view. Fluid sample processing system 10 can be, for example, an automated analyte detection and quantification system with direct sampling capabilities. Fluid sample processing system 10 can include a fluid handling robot contained within a frame or housing 11 configured for holding robotic components. System components can include a multichannel fluid-handling pipette 12, a robotic arm 13, various integrated components 14 (e.g., power supply, vacuum pump, etc.), a coupling arrangement 15 for a chip assay component, an associated imaging unit 16 (which may be integrated with the robot, or and external imaging unit), and an associated computer 17, among other possible components.

Various components within fluid sample processing system can be found in some commercially available automated robotic fluid sample processing systems. For example, fluid-handling pipette 12 and robotic arm 13 are available in many known systems. Fluid-handling pipet 12 can have multiple tips, such as 8, 12, 16 tips or more. This can serve to deliver fluids to many assay chips at once. Robotic arm 13 can move in x, y and z directions to move the fluid-handling pipet 12 to deliver fluids to assay chips located on a system module at docking arrangement 15. In many systems, fluid-handling pipets 12 (or another set of fluid-handling pipets) can also be used to remove fluids from the assay chips. These and other system components can be controlled by way of software and a computer, such as computer 17. Further details of a typical automated fluid sample processing system can be found in, for example, commonly owned PCT Patent Application No. PCT/US2021/14800 filed Jan. 22, 2021, and titled “AUTOMATED ANALYTE MEASUREMENT SYSTEMS AND KITS FOR USE THEREWITH,” which is incorporated by reference in its entirety herein. Still further details of automated fluid sample processing systems can be found in, for example, U.S. Pat. No. 10,634,673 to Araz et al., titled “ELECTROPHORETIC BAR CODE ASSAY DEVICES AND METHODS FOR MAKING AND USING THE SAME,” which is also incorporated by reference in its entirety herein.

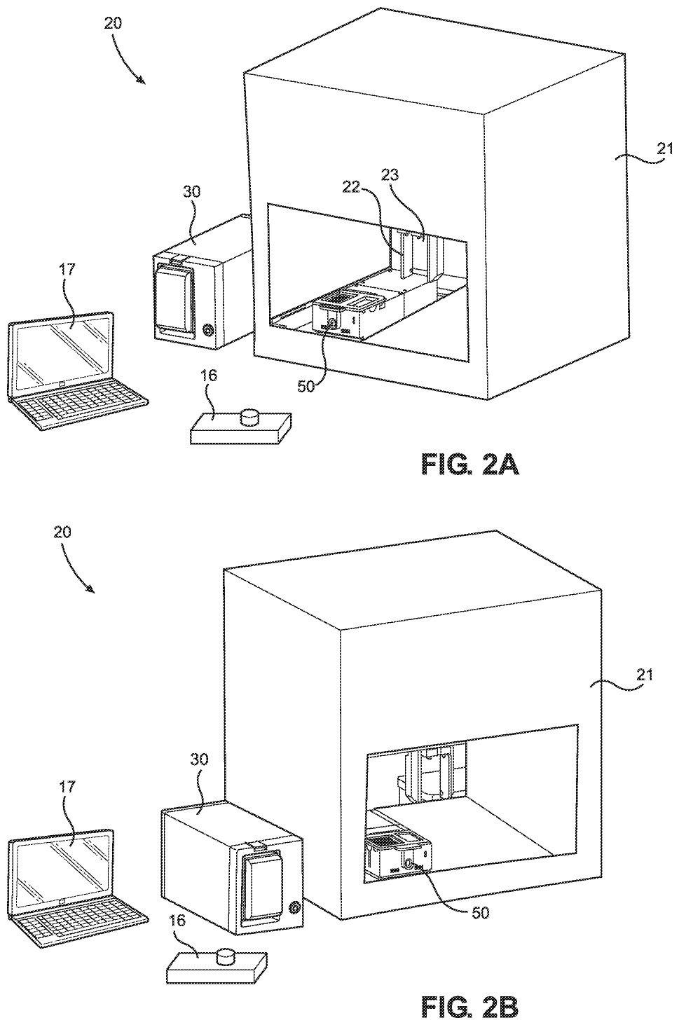

Continuing with FIGS. 2A and 2B, an example fluid sample processing system is shown in front perspective and alternative perspective views respectively. Fluid sample processing system 20 can be similar to above system 10 and can also be an automated analyte detection and quantification system with direct sampling capabilities. Fluid sample processing system 20 can also include a fluid handling robot contained within a frame or housing 21 configured for holding robotic components, which can similarly include a multichannel fluid-handling pipette 22, and a robotic arm 23. Fluid sample processing system 20 can also similarly have an associated imaging unit 16 and an associated computer 17, among other possible system components, functionalities of which will be readily understood. Associated computer 17 can have software configured to control various system functions, such as, for example, fluid sample imaging and analysis, as well as the various operations of system module 50, external box 30, and/or other possible system components, among other possible system functions. Imaging unit 16 and associated computer 17 can be considered analytic components.

Fluid sample processing system 20 as shown can be different than other fluid sample processing systems in several key aspects. Various integrated components, such as a power supply, vacuum source, waste disposal unit, and the like, can be contained in a separate external box 30 located outside housing 21. Such a separate external box 30, which can also be referred to as an “outside box” can be modular and readily installed and removed with respect to overall system 20. In addition, a system module 50 can be removably coupled inside fluid sample processing system 20, such as by way of a coupling interface. System module 50, which can also be referred to as an “on-deck module,” can be configured to be readily installed and removed with respect to overall system 20. System module 50 can also be arranged to receive and to hold assay chips for processing by the overall fluid sample processing system 20, details of which are provided below. In various arrangements, system module 50 can also be considered to be an analytic component in some regards.

In addition, fluid sample processing system 20 can be significantly different than other fluid sample processing systems with respect to the way that fluids are aspirated from the assay chips within the system. Other fluid sample processing systems traditionally aspirate or otherwise remove fluids from their assay chips from the tops of the chips by way of a pipet system, which again can be time consuming, involving many steps, with fluid removal often being inaccurate, resulting in residual fluids left behind. Conversely, fluid sample processing system aspirates fluids from its assay chips using an automated process involving aspiration channels and other features formed within a uniquely designed chip module. Such a chip module can provide improved fluid aspiration, be removable from the overall system, and be disposable, among other significant advantages.

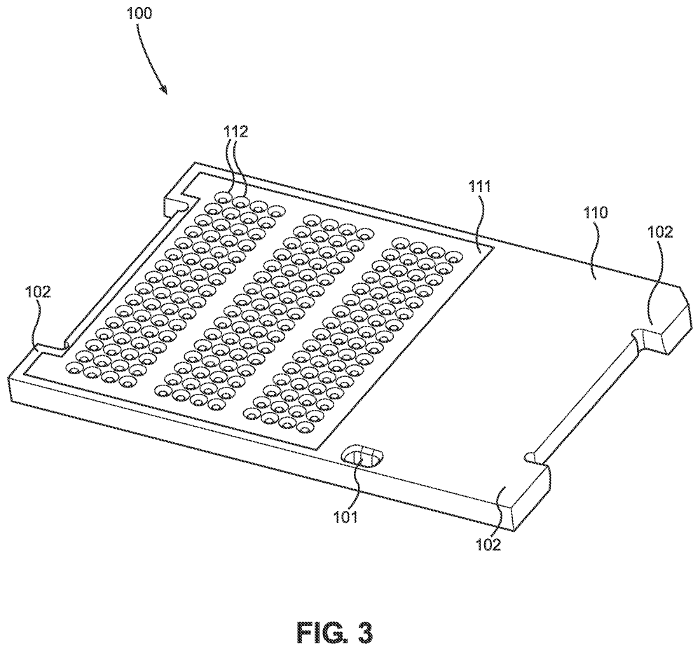

Turning next to FIG. 3, an example chip module according to one embodiment of the present disclosure is shown in top perspective view. Chip module 100, which can also be referred to as a “kit” or “cartridge,” can be a self-contained unit having one or more assay chips for the processing of fluids and the analysis of fluid contents. In various arrangements, chip module 100 can advantageously be readily and easily installed to and removed from an associated system module as a single unit, which can be significantly simpler and faster than the placement and removal of assay chips in conventional fluid sample processing systems. Chip module 100 can also be disposable, such that the entire chip module can be discarded after use. In some arrangements, one or more components of chip module 100 can be reused or recycled. For example, one or more frame components of chip module 100 can be cleaned after use and then used to form new chip modules.

In addition to pin hole 101 as noted above, multiple features 102 around the edges of chip module 100 can provide a unique shape that facilitates a precise fit of the chip module within an associated system module. Such features can include protrusions, recesses, and the like, the geometries of which can match the geometries around a reception in the associated system module, such as system module 50 shown above. In various arrangements, such features 102 and the overall geometry of chip module 100 can result in there being only one way for the chip module to fit within the reception of system module 50, such that the chip module cannot be installed backwards, upside down, or in some other incorrect orientation. Such a precise fit of the chip module within the system module can facilitate exact alignment with a robotic system or other automated fluid processing system, such that every different individual chip module installed into the system module will be properly aligned with respect to other components in the overall fluid processing system.

Chip module 100 can include a frame 110 and a cover plate 111 fitted in place within the frame and directly above assay chips arranged within the chip module. A plurality of cover openings 112 in cover plate 111 can each provide direct access to an individual assay chip disposed therebeneath. In some arrangements, cover openings 112 can be conically shaped to facilitate ease of insertion, guidance, and alignment for pipet tips into the wells below. In other arrangements, cover openings 112 need not be conically shaped and can form a cylindrical opening for pipet tip insertion. Other suitable shapes for cover openings 112 may also be used as may be desired. As shown, chip module can have 96 assay devices arranged into 6 rows of 16 assay devices per row. As will be readily appreciated though, any number of assay devices, wells, and chips arranged into any pattern can be contained within a given chip module. For example, a chip module having 8 rows of 12 assay devices can also be used.

In various arrangements, chip module 100 can be sized to industry standards for chip array processing. For example, chip module 100 can have a width of about 85 mm and a length of about 127 mm. Of course, other dimensions are also possible. Additional features and details regarding chip module 100 can be found in commonly owned U.S. patent application Ser. No. ______, entitled “AUTOMATED ANALYTE MEASUREMENT SYSTEMS AND KITS FOR USE THEREWITH,” which application is again hereby incorporated by reference in its entirety herein.

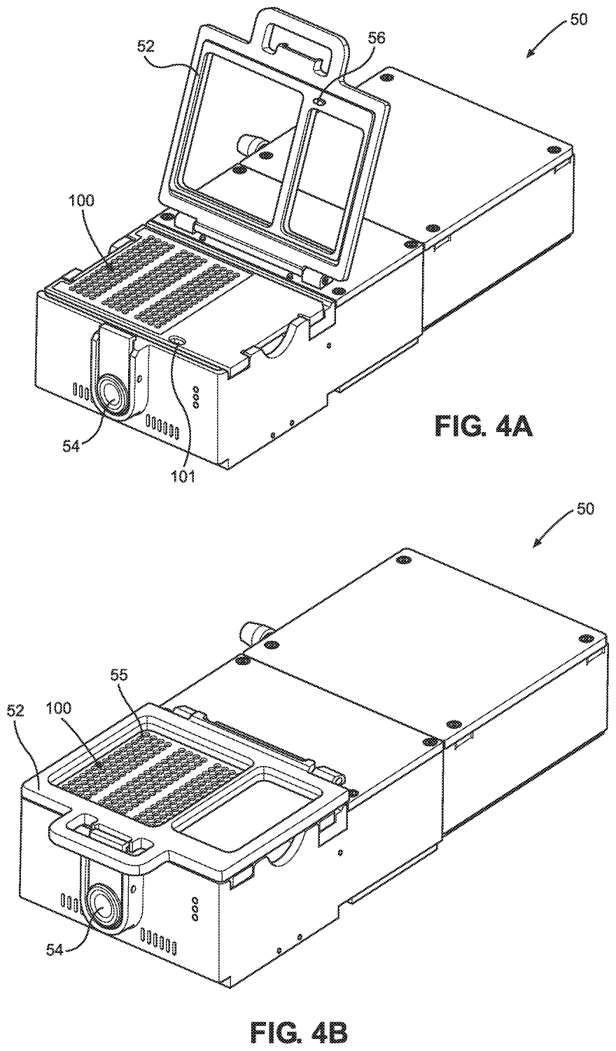

Continuing with FIGS. 4A and 4B, the chip module of FIG. 3 is shown in front perspective view as being inside an open system module and a closed system module respectively. As shown in both figures, removable chip module 100 has been placed or installed into a reception of system module 50. In FIG. 4A, lid 52 of system module 50 is open, and it can be seen that lid pin 56 of system module 50 inserts into pin hole 101 in removable chip module 100, which pin hole is aligned directly above the lid pin opening on the system module, as shown in FIG. 3. In FIG. 4B, lid 52 is closed and locked in place by the way of a mechanical snap lock mechanism of release button 54. Access opening 55 of lid 52 is aligned over the top of removable chip module 100, such that ready access is available to the tops of the assay chips therein. One or more sensors in system module 50 can confirm that chip module 100 is properly installed and/or that lid 52 is properly closed, such that further processing cannot take place without such confirmations. For example, chip module 100 can have a reflective sticker or other feature on its bottom, and system module 50 can have an optical sensor configured to detect such a sticker or feature to confirm that a chip module is properly installed therein.

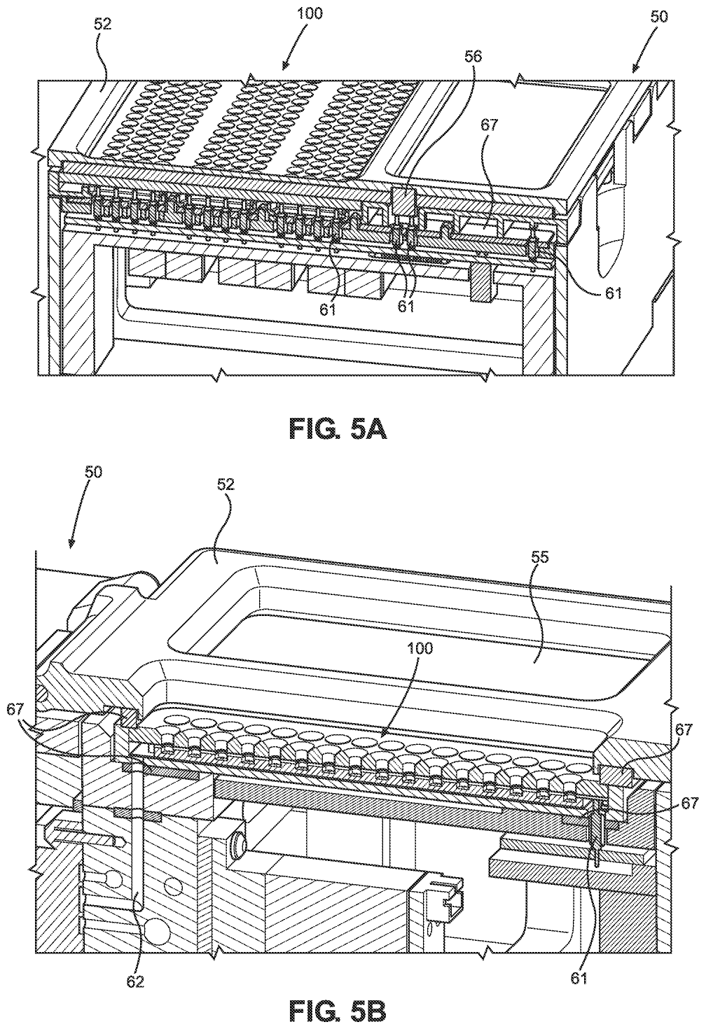

FIGS. 5A and 5B depict an example chip module within a system module in front cross-section and side cross-section views respectively. FIGS. 5A and 5B can correspond to that which is shown in FIG. 4B, where chip module 100 is installed into system module 50 with lid 52 being closed and access to the assay chips within the chip module being provided through open window 55. One or more pogo pins 61 can facilitate electrical connections between the system module 50 and the chip module 100 when the chip module is properly installed within the system module and lid 52 is closed. Various aspiration passages 62 within system module 50 can facilitate aspiration from the assay chips within chip module 100, such as by way of a vacuum applied to a vacuum port within the system module. Regulation of the vacuum can be provided by a series of valves within the pneumatic submodule of system module 50.

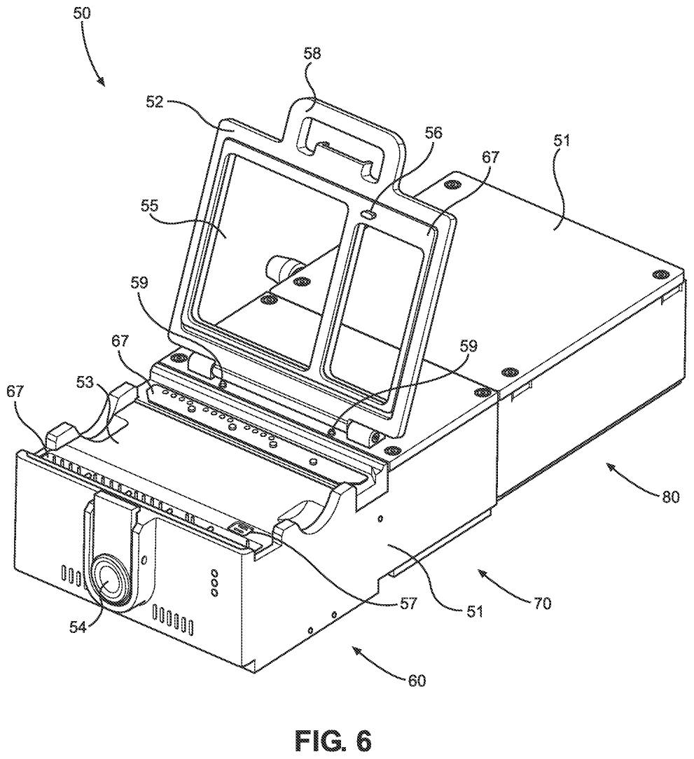

As shown in FIG. 5A, lid pin 56 can be in contact with one or more pogo pins 61 when lid 52 is closed and the lid pin is inserted through a pin hole in the chip module (shown as 101 in FIG. 3) and a lid pin opening in the system module (shown as 57 in FIG. 6 below). An electrical connection can be formed when lid pin 56 contacts and actuates pogo pins 61 when lid 52 is closed, which electrical connection can provide confirmation to the system that the lid is properly shut. In various arrangements, the system can be configured to perform various operational functions only when a chip module is installed into the system module and the lid is confirmed to be closed. Other sensors or detection arrangements can confirm that a chip module is installed into the system module, as noted below.

In various arrangements, one or more gaskets 67 can be used on system module 50 at one or more locations where parts of the system module contact chip module 100. Such a gasket(s) 67 can facilitate a firm contact between system module 50 and chip module 100 and can also provide a seal within the system between the system module and chip module. Accordingly, gasket(s) 67 can be formed from a pliable material, such as rubber or foam, for example, which material can be compressed to facilitate a seal when lid 52 is closed atop. One o more gaskets 67 can be placed, for example, along a bottom surface of lid 52 where the lid contacts the chip module, as well as around an upper surface of the system module where the system module receives the chip module, as shown.

Transitioning now to FIG. 6, an example system module for a fluid sample processing system is illustrated in front perspective view. System module 50, which again can be readily installed and removed from an overall fluid sample processing system, can generally include three submodules-an aspiration submodule 60, a pneumatic submodule 70, and a control submodule 80. Each of these submodules 60, 70, 80 will be discussed in greater detail below.

Overall, system module 50 can include an outer housing 51, a lid 52, a reception 53 for a removable chip module, a release button 54, and various gaskets 67 among numerous other components and features. Outer housing 51 can comprise a unibody outer housing for both the aspiration submodule 60 and the pneumatic submodule 70. As shown in FIG. 5, lid 52 is open and no chip module is in place within reception 53. Lid 52 can include an access opening 55 or window, which can be substantially sized, such that pipet access can be had to a chip module when the chip module is installed within reception 53 and the lid is closed. Lid 52 can also include a lid pin 56, which can fit through a corresponding pin hole in an installed chip module and then into a lid pin opening 57 adjacent to reception 53. Lid 52 can also include a handle 58 to facilitate the ready opening and closing of the lid. Release button 54 can be pushed to release lid 52 when the lid is in a closed position and can mechanically snap shut when the lid is closed in order to lock an installed chip module firmly in place within the system module 50. One or more spring loaded pins 59 can push against lid 52, causing the lid to pop open slightly when release button 54 is pushed.

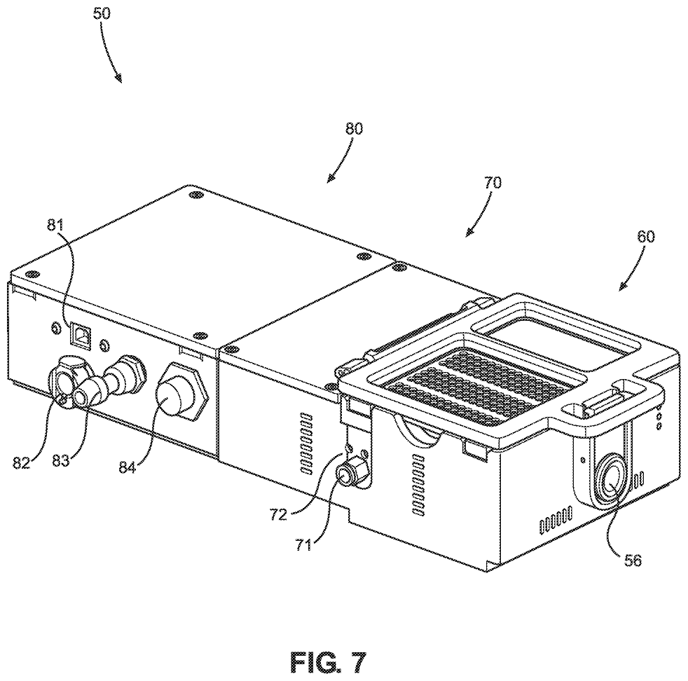

Continuing with FIG. 7, an example system module is shown in obverse side perspective view. Additional components found on the exterior of system module 50 can include ports 71, 72 on pneumatic submodule 70 and ports 81, 82, 83, 84 on control submodule 80.

Vacuum port 71 can be coupled to a tube or other connector that provides main vacuum access to the entire system module 50 into pneumatic submodule 70. Vacuum can be provided through vacuum port 71 from an outside source, such as a pump or other vacuum source in an external box, and fluids from within system module 50 can be collected by vacuum and dispersed to a vacuum trap at the external box, for example. One or more ports in the form of vent holes 72 in the housing of pneumatic submodule 70 can serve to vent pressure or vacuum in order to stabilize the pressure as needed within the overall system module 50.

Communications port 81 can provide communications between a processor in control submodule 80 and an outside computer or other processing unit. Communications port 81 can be, for example, a USB connector. Pressure sensor connection port 82 can provide a connector for a pressure sensor located within control submodule 80. First electrical connector 83 can provide a first set of electrical connections for one or more components within control submodule 80 and/or pneumatic submodule 70. Second electrical connector 84 can provide a second set of electrical connections for one or more components within control submodule 80 and/or pneumatic submodule 70.

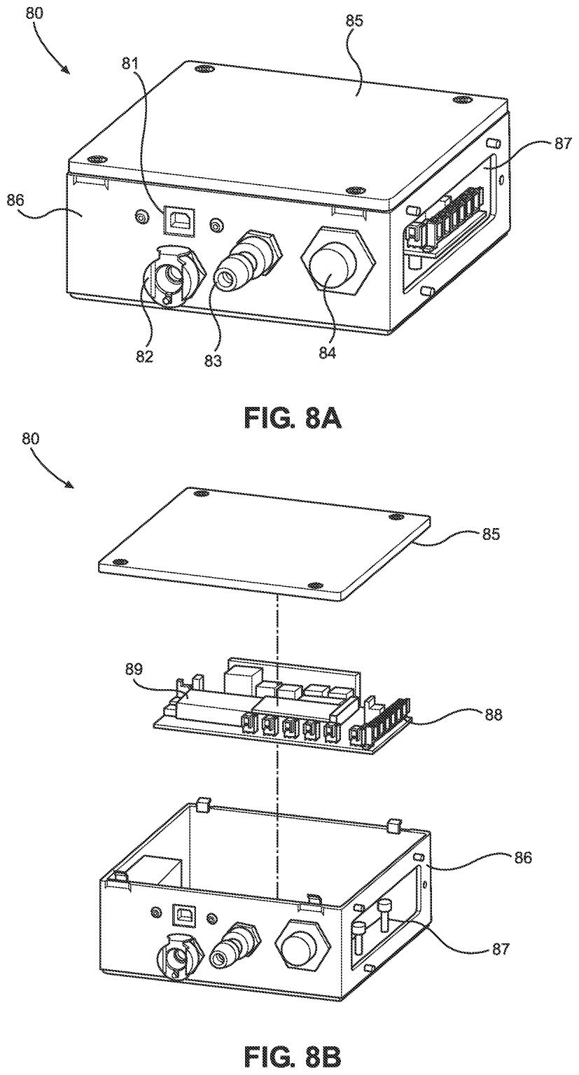

FIGS. 8A and 8B illustrate an example control submodule of a system module in obverse side perspective and exploded views respectively. In addition to the items noted above with respect to FIG. 7, control submodule 80 can also include a control top plate 85 that couples to and is removable from an outer housing 86, such as to provide access to the various components inside the control submodule. Outer housing 86 can include an internal opening or window 87 between control submodule 80 and the pneumatic submodule (not shown). Inside control submodule 80 can be situated a circuit board 88 having one or more processors or controllers 89, which can be coupled to various system module components (e.g., valves) and serve to control the valves and other operations of the system module.

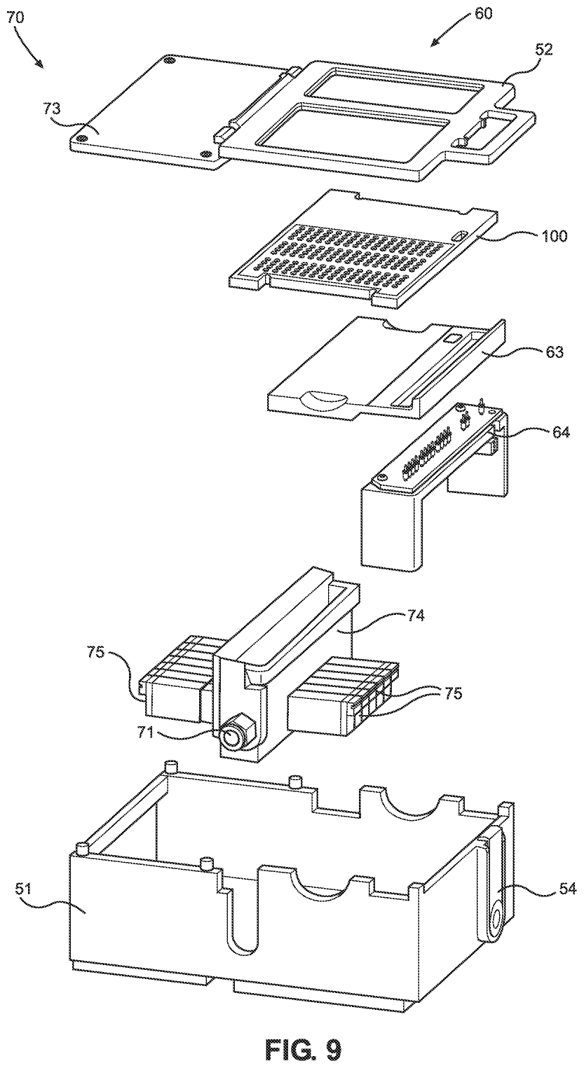

Moving next to FIG. 9, example aspiration and pneumatic submodules of a system module are shown in exploded view. Again, a unibody housing 51 can contain internal components of both the aspiration submodule 60 and the pneumatic submodule. In addition to the components set forth above, pneumatic submodule 70 can include a pneumatic top plate 73 that couples to and is removable from unibody housing 51, such as to provide access to the various components inside the pneumatic submodule.

Pneumatic submodule 70 can also include a valve manifold 74 having a plurality of valves 75 configured to deliver vacuum to various pneumatic passages within aspiration submodule 60. As noted above, valves 75 can be controlled by a processor in the control submodule. In various embodiments, multiple sets of valves 75 can be arranged within valve manifold 74. For example, a first set of six valves 75 can control vacuum or pressure delivered to six different pneumatic passages within aspiration submodule 60, and a second set of seven valves 75 can control vacuum or pressure delivered to six more different pneumatic passages within the aspiration submodule. In some arrangements, one valve on valve manifold 75 can be used as a vent valve to regulate overall vacuum or pressure throughout the system. Vacuum levels throughout system module 50 can be regulated in a variety of ways using one or more controllers in the control submodule. Regulating vacuum levels can involve, for example, accelerating, slowing, or stopping the vacuum pump, achieving a desired pressure in various areas both in the system module and external box, such as the removable waste disposal unit, and by controlling passive steady state leaks at various points in the overall system.

The use of multiple valves 75 can allow overall system module 50 to provide vacuum to different pneumatic passages in a controlled manner. For example, it can often be desirable to deliver vacuum to and aspirate select row(s) and or column(s) of assay wells, devices, or chips at a given time, but not to deliver vacuum to other rows or columns of assay wells, devices, or chips in a given chip module 100. This can allow fluid to be aspirated from some assay wells, devices, or chips while fluid is being held within or delivered to other assay wells, devices, or chips, for example.

Various components contained within aspiration submodule 60 can include a baffle plate 63 that can form reception 53 (as noted above) and can be removably coupled atop unibody housing 51. Aspiration submodule 60 can also include a support bracket 64 configured to support various items within the aspiration submodule, such as, for example, various pogo pins, electrical connectors, sensors, lights, other indicators, and the like. Further details regarding support bracket 64 and its associated components are provided below.

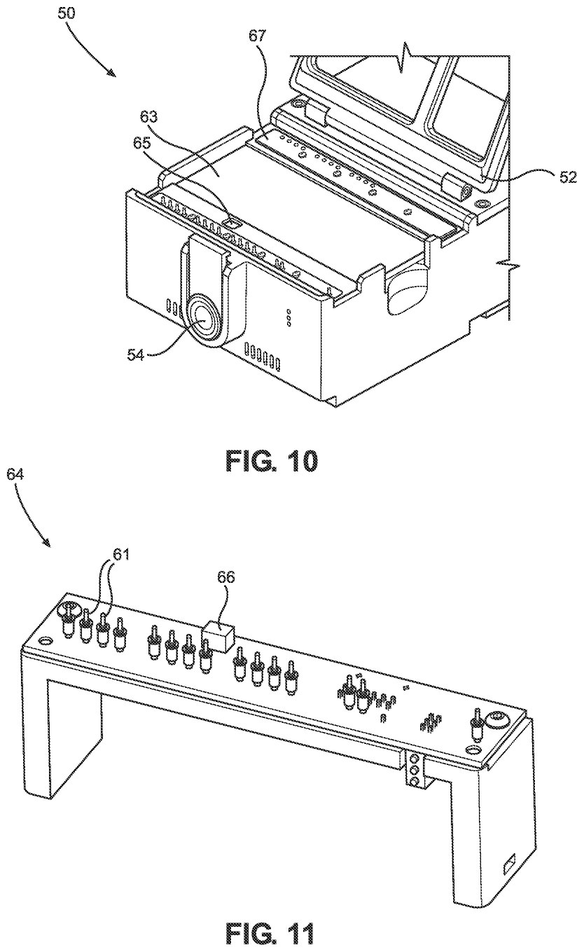

FIG. 10 illustrates in top perspective view an example aspiration submodule of a system module. As shown, lid 52 is open to reveal baffle plate 63, which forms the reception configured to receive a removable chip module (not shown). A sensor opening 65 in baffle plate 63 can provide optical access for an optical sensor located therebeneath.

FIG. 11 shows in top perspective view an example support bracket for an aspiration submodule. Support bracket 64 can include multiple pogo pins 61 mounted thereto, which pogo pins can provide electrical connections to a chip module installed within the system module. Optical sensor 66 can also be mounted to support bracket 64, and this optical sensor can be configured to detect when the chip module is installed and/or the lid of the system module is closed, such as through sensor opening 65 shown in FIG. 10.

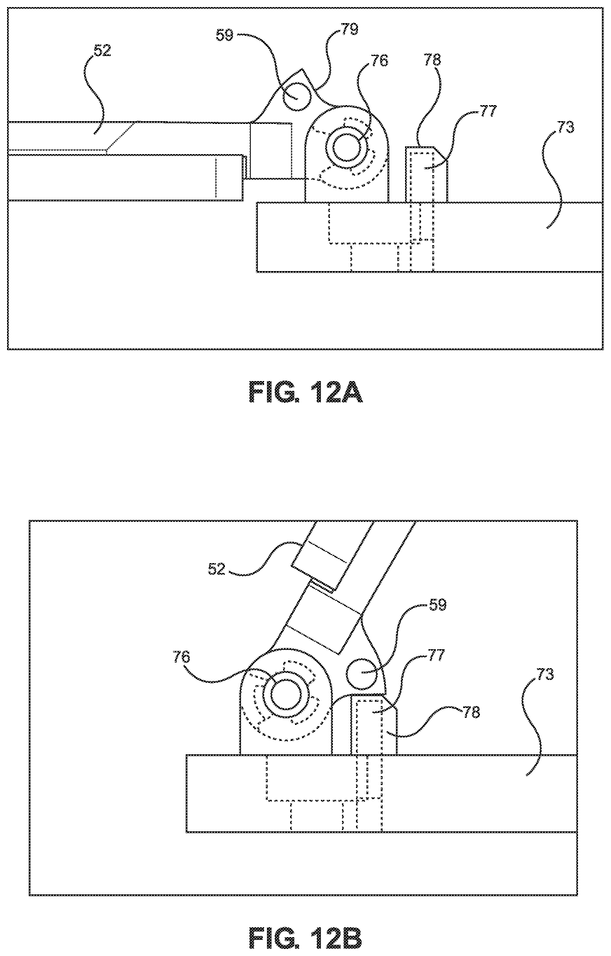

Moving next to FIGS. 12A and 12B an example holding arrangement for a lid of a system module is illustrated in side elevation views with the lid in a closed position and the lid in an open position respectively. While the mechanical button latch arrangement discussed above can serve to lock lid 52 in place when it is closed atop the system module, a separate holding arrangement can serve to hold the lid in place when it is opened. Lid 52 can be coupled atop pneumatic top plate 73 by way of a hinge 76. Lid 52 can have a protrusion near the hinge that can have a metal plug 59 inside and a stopping surface 79. Pneumatic top plate can have a magnet 77 inside a post 78 having a top surface configured to contact stopping surface 79 of the lid 52. As can be seen in FIG. 12B, when lid 52 is in a fully opened position, stopping surface 79 contacts the top of post 78 to stop any further rotational movement of the lid. Magnetic attraction from magnet 78 to metal plug 59 can then provide a positive force to keep lid 52 in a fully open position until the lid is closed with sufficient force to overcome this magnetic attraction. In some arrangement, gravity can also serve to keep lid 52 in a fully open position.

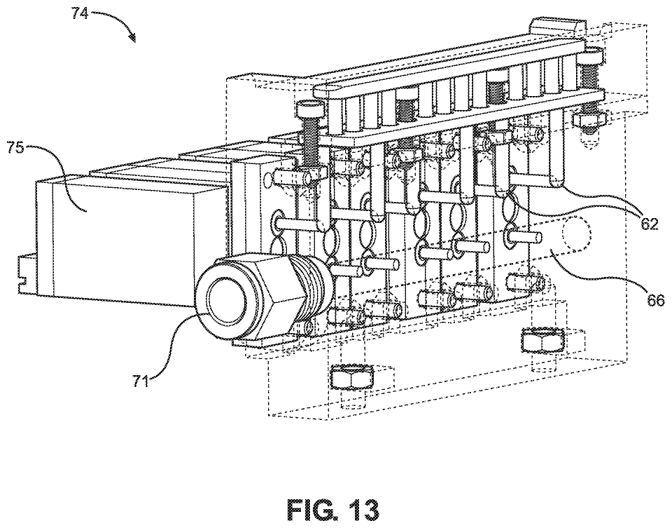

FIG. 13 depicts an example pneumatic manifold for use within a pneumatic submodule of a system module in side perspective view. Valve manifold 74 can have a plurality of valves 75 configured to provide vacuum selectively to numerous aspiration passages 62 that are integrally formed within the pneumatic and aspiration submodules of a system module. Each of these aspiration passages 62 can directly or indirectly couple to a main vacuum line 66, which in turn is directly coupled to vacuum port 71 and the outside vacuum source. Again, actuation of a given valve 75 in valve manifold can provide vacuum to a given aspiration passage 62, which in turn provides vacuum to a given row or column of wells in an associated chip module. In some arrangements, a given valve 75 may control vacuum distribution to multiple rows or columns of assay chip wells.

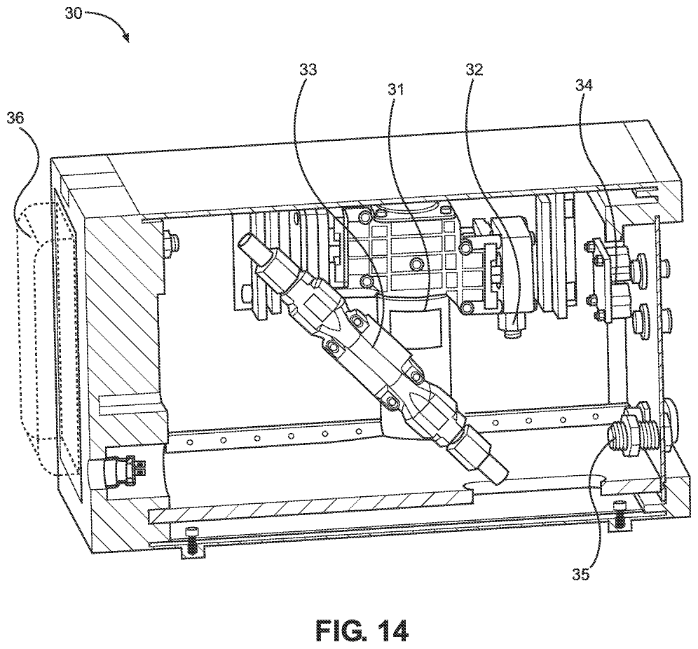

Turning next to FIG. 14 an example external box is illustrated in side perspective and partial cutaway view. External box 30, which can also be called an “outside box,” can be considered as a waste disposal module in some arrangements. External box 30 can be modular with respect to an overall fluid sample processing system such that it can be readily and easily installed with respect to the overall system. External box 30 generally serves to provide a vacuum source to the system module and to collect waste fluids from the system module.

External box 30 can contain various components that may be unsuitable for being within the system module or other overall system components. Such external box components can include, for example, a pump 31 configured to generate a vacuum, one or more pump inlets and outlets 32, a flow sensor 33 configured to detect flow rates, a fan 34 configured to cool external box 30, and one or more port connectors 35 configured to couple the pump (i.e. vacuum source) to the system module, among other components.

External box 30 (i.e., waste disposal module) can also include a removable waste disposal unit 36 coupled to the vacuum pump 31 within the external box and to the system module via port connectors 35. Removable waste disposal unit 36 can be configured to hold waste materials from the system module, such as various fluids aspirated from the system module. As will be readily appreciated, vacuum generated by pump 31 can provide the vacuum to the system module to aspirate and remove waste materials from the system module and then deposit the waste materials into removable waste disposal unit 36, which can be removed from external box 30 as needed to empty the waste contents therefrom and then be reinstalled.

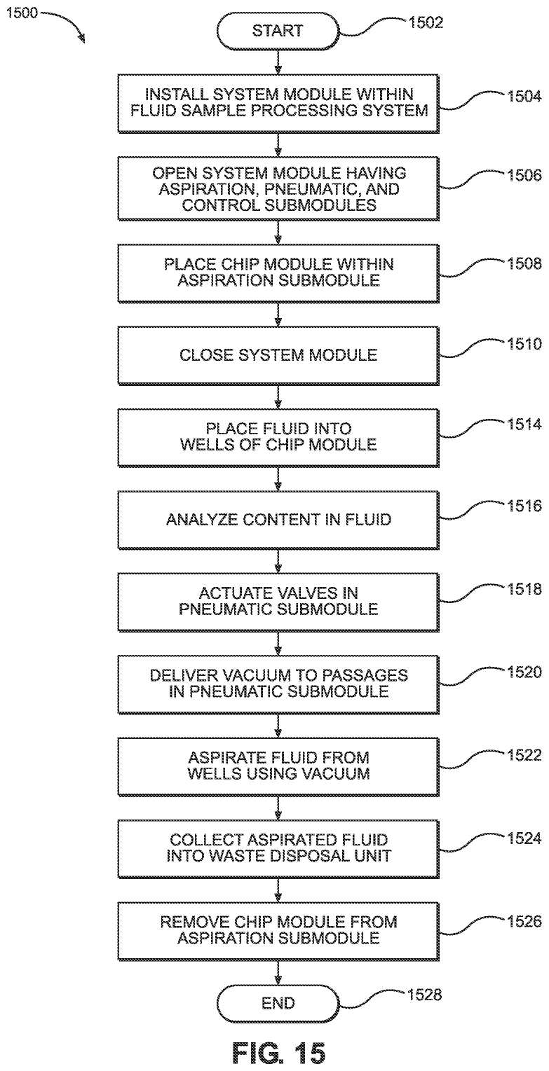

Lastly, FIG. 15 presents a flowchart of an example method of processing fluid samples. Such processing can involve the detection, identification and quantification of small molecules and macromolecules, although other fluid processing applications are also possible. In various embodiments, method 1500 can be applied using the various systems, modules, apparatuses and features provided above.

After a start step 1502, a first process step 1504 can involve installing a system module within a fluid sample processing system. This can involve using a customized bracket or other interface designed to couple both to the system module and to a specific make and module of an overall fluid sample processing system, for example. Various electrical and pneumatic connections can also be made when installing the system module within an overall system.

At the next process step 1506, the system module can be opened. Again, the system module can have an aspiration submodule, a pneumatic submodule, and a control submodule. Opening the system module can involve raising a lid on the aspiration submodule, which can be facilitated by pushing a release button, for example.

At a following process step 1508, a chip module can be placed within the aspiration submodule of the system module. As noted above, the removable chip module can include one or more assay chips arranged into one or more rows, and the one or more assay chips can include one or more wells configured to hold fluid therein and one or more aspiration channels connected to the one or more wells. The chip module can be placed into a reception located within the aspiration submodule.

At the next process step 1510, the system module can be closed with the chip module placed inside. This can involve closing the lid on the system module, as detailed above. In various embodiments, the process steps of opening the system module, placing the chip module, and closing the system module can be automated or can be manually accomplished.

At a subsequent process step 1514, fluid can be placed into the one or more wells. This can involve, for example, a pipet system placing the fluid into the tops of the wells. As will be readily appreciated, the pipet system can be robotically controlled, such as by a robotic arm that is automatically operated by a software program on an associated computer.

At a following process step 1516, fluid content in the placed fluid can be analyzed. This can take place using any of various well-known fluid analysis procedures. Fluid can be analyzed, for example, for the presence of and characteristics of various molecules and macromolecules. Analyzing fluid content can be accomplished, for example, by way of applying a voltage to electrodes that are in the wells, and then observing characteristics of the fluid as a result, as will be readily appreciated.

At the next process step 1518, the valves in the pneumatic submodule can be actuated. This can take place after fluid content has been analyzed and removal of the fluid is desired. In various embodiments, a processor in the control submodule can actuate the valves in the pneumatic submodule.

At process step 1520, a vacuum can be delivered to passages in the pneumatic submodule. Vacuum can be delivered as a result of the valves being actuated in step 1518. In some arrangements, a pump or vacuum source may keep a constant vacuum applied to pneumatic passages and a pneumatic manifold within the pneumatic submodule. In other arrangements, the pump or vacuum source may be activated when the valves are actuated.

At the next process step 1522, the fluid can be aspirated from the wells using the vacuum. This can involve aspirating or otherwise removing the fluid from the bottoms and/or the sides of the wells, rather than from the tops, which can be accomplished using the various components and features disclosed above, such as a chip module having aspiration channels at the bottoms and/or the sides of the wells. Aspiration can be facilitated by applying a vacuum to the bottoms and/or the sides of the wells, as set forth above. Aspiration of the fluid from the wells can take place for multiple wells simultaneously. In some arrangements, all wells can be aspirated at once. In some embodiments, a subset of all of the wells can be aspirated simultaneously, such as by pairs sharing a common trench or by rows.

At subsequent process step 1524, aspirated fluid can be collected into a waste disposal unit. This can involve the fluid being completely removed from the system module and passed through one or more pneumatic connections to an external box having a removable waste disposal unit, as set forth above.

At a following process step 1526, the removable chip module can be removed from the system. In particular, the chip module can be removed from the aspiration submodule of the system module. This can involve opening the lid on a system module and then removing the chip module from the system module. Similar to providing the removable chip module, this process can be automated or can be accomplished manually. Where automated, one or more robotic arms or other automated components can remove the chip module. As noted above, opening the lid on the system module can involve pressing a button release or other actuation component. The method then ends at end step 1528.

It will be appreciated that the foregoing method may include additional steps not shown, and that not all steps are necessary in some embodiments. For example, additional steps may include imaging, as well as installing and operating an external box. Other process steps can involve multiple cycles of placing fluid and aspirating fluid prior to analyzing fluid content of a fluid of interest, such as during a buffer or flush cycling process. Furthermore, the order of steps may be altered as desired, and one or more steps may be performed simultaneously. For example, process steps 1518 through 1524 may be performed simultaneously in some arrangements. In various arrangements, process steps 1514 through 1524 may all be automatically performed by a robotic system. In systems where additional robotic arms are used, all process steps may be automatically performed by a robotic system.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

What is claimed is:

1. A system module configured for use with a separate fluid sample processing system, the system module comprising:
an aspiration submodule configured to receive a separate chip module having one or more assay devices and to provide aspiration for the separate chip module;
a pneumatic submodule coupled to the aspiration submodule, the pneumatic submodule including a plurality of passages configured to deliver vacuum to and receive fluids from the separate chip module and one or more valves coupled to the plurality of passages; and
a control submodule coupled to the pneumatic submodule, the control submodule including a controller configured to operate the one or more valves.

2. The system module of claim 1, wherein the system module is configured to be installed into and removed from the separate fluid sample processing system.

3. The system module of claim 1, wherein the aspiration submodule and the pneumatic submodule are contained within a unibody outer housing.

4. The system module of claim 1, wherein the aspiration submodule includes:
a reception configured to receive the separate chip module;
a lid configured to allow the separate chip module to be inserted and removed to the reception;
one or more electrical connections configured to deliver voltage to the separate chip module; and
one or more pneumatic ports configured to deliver vacuum to and receive fluids from the separate chip module.

5. The system module of claim 4, wherein the system module is configured to perform operations on the separate chip module when the separate chip module is within the aspiration submodule and the lid is closed.

6. The system module of claim 1, further comprising:
one or more coupling components configured to couple the system module to the separate fluid sample processing system

7. The system module of claim 1, wherein the one or more valves are arranged into at least one valve manifold within the pneumatic submodule.

8. The system module of claim 1, wherein the control module further includes a communication interface configured to facilitate communication with a separate processor.

9. The system module of claim 1, wherein the aspiration submodule includes one or more sensors configured to detect the presence of the separate chip module within the aspiration submodule.

10. A fluid sample processing subsystem configured for use with an overall fluid sample processing system, the fluid sample processing subsystem comprising:
a system module including:
an aspiration submodule configured to receive a removable chip module having one or more assay devices and to provide aspiration for the separate chip module,
a pneumatic submodule coupled to the aspiration submodule, the pneumatic submodule including a plurality of passages configured to deliver vacuum to and receive fluids from the removable chip module and one or more valves coupled to the plurality of passages, and
a control submodule coupled to the pneumatic submodule, the control submodule including a controller configured to operate the one or more valves; and
a waste disposal module configured to be coupled to the system module, the waste disposal module including:
a removable waste disposal unit configured to hold waste materials from the system module, and
a vacuum source coupled to the removable waste disposal unit, wherein the vacuum source is configured to provide a vacuum to the system module to remove the waste materials from the system module and deposit the waste materials into the removable waste disposal unit.

11. The fluid sample processing subsystem of claim 10, further comprising:
the removable chip module.

12. The fluid sample processing subsystem of claim 11, wherein the removable chip module includes one or more assay devices arranged into one or more rows, the one or more assay devices including:
one or more wells configured to hold fluid therein, and
one or more aspiration channels connected to the one or more wells, wherein the one or more aspiration channels are configured to aspirate fluid from the bottoms or the sides of the one or more wells.

13. The fluid sample processing subsystem of claim 10, further comprising:
a processing component configured to analyze fluid content within the removable chip module.

14. The fluid sample processing subsystem of claim 10, further comprising:
an interface component configured to couple the system module to a separate fluid sample processing system.

15. A method of processing fluid samples, the method comprising:
opening a system module installed within a separate fluid sample processing system, the system module including an aspiration submodule, a pneumatic submodule, and a control submodule;
placing a chip module within the aspiration submodule, the chip module including one or more assay devices arranged into one or more rows, the one or more assay devices including one or more wells configured to hold fluid therein and one or more aspiration channels connected to the one or more wells;
closing the system module with the chip module placed therein;
placing a fluid into the top of each of the one or more wells while the system module remains closed;
analyzing content in the fluid within the one or more wells while the system module remains closed;
actuating one or more valves within the pneumatic submodule while the system module remains closed, the actuating being performed by the control submodule;
delivering a vacuum to a plurality of passages within the pneumatic submodule, the delivering a vacuum resulting from the actuating; and
aspirating the fluid by way of the vacuum from the bottom or the side of each of the one or more wells while the system module remains closed.

16. The method of claim 15, wherein the placing, the analyzing, the actuating, the delivering, and the aspirating are all automatically performed by a robotic system.

17. The method of claim 15, wherein the aspirating of the fluid occurs simultaneously for all of the one or more wells.

18. The method of claim 15, further comprising the step of:
removing the chip module from the aspiration submodule.

19. The method of claim 15, further comprising the step of:
collecting aspirated fluid into a waste disposal unit.

20. The method of claim 15, further comprising the step of:
installing the system module within the separate fluid sample processing system.
